(19) United States
(12) Patent Application Publication
(10) Pub. No.: US 2006/0078158 A1
(43) Pub. Date: Apr. 13, 2006

(54) Viewing masked images

(76) Inventors: Coen Theodorus Hubertus Fransiscu Liedenbaum, Eindhoven (NL); Robert Frans Maria Hendriks, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/548,246

(22) PCT Filed: Mar. 1, 2004
(86) PCT No.: PCT/IB04/50178

§ 371 Date: Sep. 6, 2005

(30) Foreign Application Priority Data
Mar. 11, 2003 (EP) 03100605.9

(51) Int. Cl. G06K 9/00; G06K 9/36

(52) U.S. Cl. 382/100; 382/232

(57) ABSTRACT

For displaying a target image contained in a sequence of first images (11) interspersed with second images (12) constituting a masking image, a display device is arranged for substantially exclusively displaying the first images and suppressing the second images in response to a key (13). The display device may be provided with an LCD screen which is only illuminated when first images are displayed. Color coding may be used to further enhance the security of the device.

The present invention relates to the viewing of masked images. More in particular, the present invention relates to a device and a method for viewing images that have been masked for security reasons.

Visual information may be masked to avoid the information being obtained by non-authorized persons. This may in particular be desirable when the information is secret or confidential, as is the case with bank balances, personal messages (e-mail), and other personal information, and when this information is displayed on the screen of a computer screen, PDA (Personal Digital Assistant), mobile telephone, or similar device.

U.S. Pat. No. 5,614,920 discloses an apparatus for masking a displayed image by merging it with a second featureless image made of short pulses of light that are introduced into a transparent screen disposed between the display and the viewer. An electronic shutter timed to match the sequence of the masking light pulses separates or blocks the masking image to permit the primary image to be viewed only by the person having the electronic shutter. As only a single primary image is displayed, there is no synchronization between the shutter and the primary image.

European Patent Application EP 1 229 422 discloses a device for displaying a sequence of images, each image containing either actual data which provide the image to be conveyed or “garbage data” providing a masking image. A viewing device is blocked when the masking image is displayed, thus permitting the person using the viewing device to view the actual image.

Both Prior Art devices suffer from the disadvantage that a separate viewing device is necessary to block the masking image, it is not possible to directly view the actual or target image. The use of a separate viewing device is cumbersome and relatively expensive.

It is therefore an object of the present invention to overcome these and other problems of the Prior Art and to provide a device for and a method of displaying a masked image which does not require the use of a separate viewing device.

Accordingly, the present invention provides a display device for displaying a target image contained in a sequence of first images interspersed with second images constituting a masking image, the display device being arranged for substantially exclusively displaying the first images in response to a key sequence.

That is, the display device of the present invention only shows the first images while the second images are not made visible, thus effectively removing the masking image. It should be noted that it is not essential for all second images not to be shown and that embodiments can be envisaged in which most, but not all, second images are not made visible. Conversely, embodiments can be envisaged in which most, but not all, first images are displayed.

The selection of the images to be displayed, that is of the first images, is carried out by means of a key. The key may for example comprise a sequence of “1”s and “0”s, each “1” corresponding with an image to be displayed (that is, a first image) and a “0” corresponding with an image to be suppressed (that is, a second image).

In one embodiment, the display device comprises a display screen which substantially exclusively displays the first images. That is, the display screen displays, under the control of the key, only the first images; when a second image of the sequence is supplied to it, the display screen is featureless (preferably entirely black). Such a display screen may be a luminous screen, such as the screen of a CRT (Cathode Ray Tube).

In a preferred embodiment, the display device comprises a non-luminous display screen complemented with an illumination device for illuminated a non-luminous displayed image, wherein the illumination device is arranged for substantially exclusively illuminating the first images in response to the key. It is noted that in contrast to U.S. Pat. No. 5,614,920 the preferred embodiment of the present invention utilizes pulses of light to display the actual or target image, not to produce a masking image. In addition, the masking image of the present invention is not necessarily featureless but may be any image, for example a negative of the target image, thus providing an enhanced masking action. Moreover, the pulses of light are synchronized with the images.

It is further noted that in contrast to EP 1 229 422 the present invention selectively displays the actual images rather than first displaying all images and then filtering out the masking images. In other words, the present invention selects the images to be displayed in the display device, not in a viewing device.

The key preferably comprises a sequence of values, each value corresponding with a first image or a second image and indicating whether the respective image is to be displayed.

In a particularly advantageous embodiment, the first and/or second images are each constituted by at least two sub-images having complementary colors, the illumination device being capable of producing at least two corresponding colors, and wherein the key comprises a color indication. In this embodiment, the security is enhanced as the target image or images can only be correctly displayed if both the second images are substantially suppressed and the first images are illuminated using the right color. Illuminating the first images using an incorrect color will normally result in the particular first image not being visible. Preferably three complimentary colors are used, typically red, green and blue.

The present invention further provides a system for securely distributing images, the system comprising sequence production means for producing a sequence of first images together constituting a target image, for interspersing said sequence of first images with second images constituting a masking image, and for generating a key indicative of the location of the first and/or second images in said sequence, a display device for displaying the target image, and transmission means for transmitting the said sequence to the display device, wherein the display device is arranged for substantially exclusively displaying the first images in response to a key.

The present invention additionally provides a method of displaying a target image contained in a sequence of first images interspersed with second images constituting a masking image, the method comprising the step of substantially exclusively displaying the first images in response to a key.

The present invention will further be explained below with reference to exemplary embodiments illustrated in the accompanying drawings, in which:

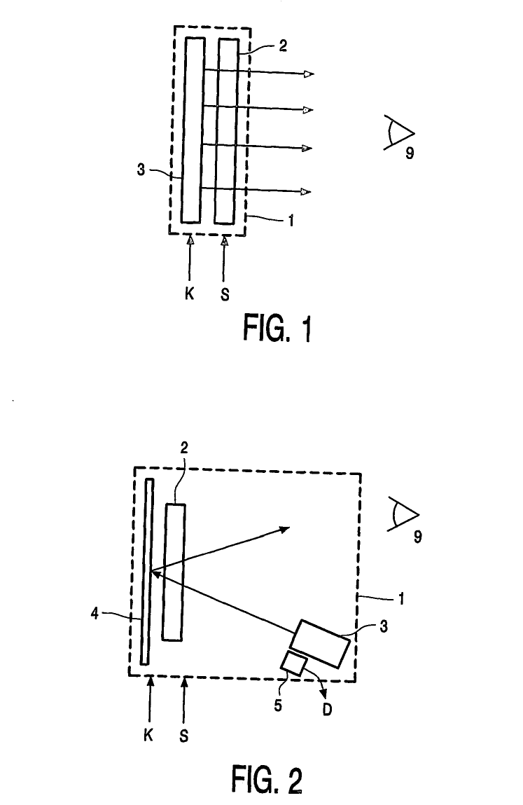

FIG. 1 schematically shows a first embodiment of a display device according to the present invention.

FIG. 2 schematically shows a second embodiment of a display device according to the present invention.

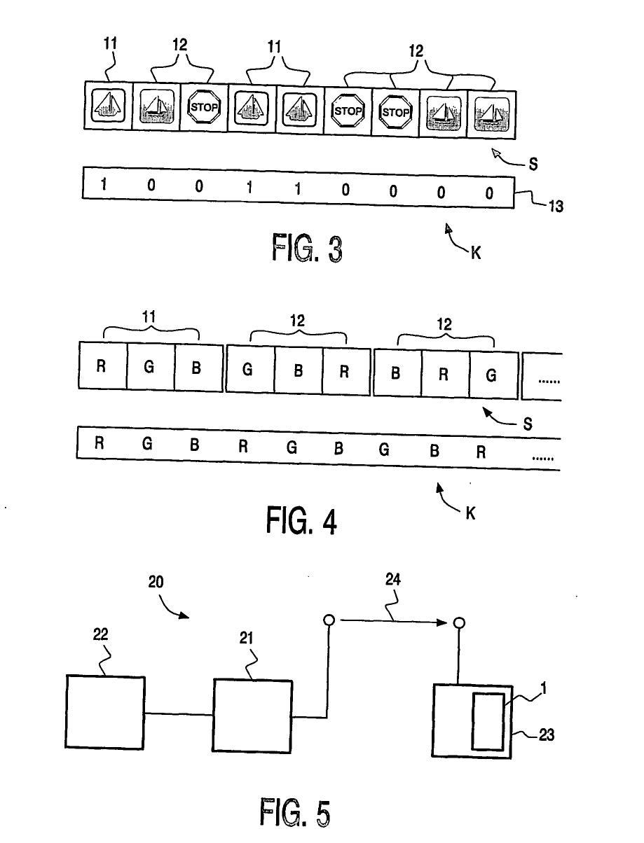

FIG. 3 schematically shows a sequence of first and second images according to a first embodiment of the present invention, and a corresponding key.

FIG. 4 schematically shows a sequence of first and second images according to a second embodiment of the present invention, and a corresponding key.

FIG. 5 schematically shows a system for transmitting images according to the present invention.

The display device 1 shown merely by way of non-limiting example in FIG. 1 comprises a display screen 2 and an illumination unit 3. In the embodiment shown, the display screen 2 is an LCD (Liquid Crystal Display) screen and the illumination unit 3 is a backlight unit which illuminates the translucent screen from behind. Together the display screen 2 and the illumination unit 3 produce a luminous image which may be viewed by a viewer 9. A sequence S of images, which will be further explained below with reference to FIG. 3, and a key K are supplied to the display device 1, as is symbolically indicated in FIG. 1. The key K, which will be further explained below with reference to FIG. 3, may be stored or produced in a separate key unit (not shown), or may be permanently stored in the illumination unit within the display device 1.

In the embodiment of FIG. 2, the display device 1 also comprises a display screen 2 and an illumination unit 3. In this embodiment, however, the illumination unit 3 is constituted by a front light unit which illuminates the front of the display screen 2 so as to produce a luminous image which may be viewed by a viewer 9. A reflector 4 may in this embodiment be positioned behind the display screen 2.

In either embodiment, the display device 1 may further comprise a processor and an associated memory for processing data, such as key data and image data, and an optional card reader for interfacing with a smart card or another identification device (token). These (optional) components are not shown in FIGS. 1 and 2 for the sake of clarity of the illustration.

A sequence of images is depicted in FIG. 3. The sequence S consists of first images 11 and second images 12. The first images 11 constitute the actual image which is to be displayed, also referred to as the target image. Although all first images 11 are shown to be identical in FIG. 3, embodiments can be envisaged in which not all first images are identical, in particular where different first images 11 contain parts of the target image. If no single first image 11 contains the entire target image, the security is further enhanced. The second images 12, which do not contribute to the target image but serve to mask the target image, may all be identical. However, in the embodiment shown there are two distinct types of second images: one is the negative image of the target image and serves to cancel out the visual impression of the actual image when viewed by an unauthorized viewer, while the other is a masking image.

A corresponding key 13 according to the present invention is also shown schematically in FIG. 3. The exemplary key 13 is shown to consist of a string of “1”s and “0”s, each “1” corresponding with a first image 11 and each “0” corresponding with a second image 12. In other words, each “1” indicates that the corresponding image is to be displayed while each “0” indicates that the corresponding image is not to be displayed. In accordance with the present invention, therefore, the display device 1 only displays the first images 11 and does not display the second images 12. As a result, the viewer 9 will be able to view the target image without the need for a shutter device or other auxiliary device. Any display device in which the correct key 13 is not present will produce the masking image, not the target image.

Displaying the first images and not displaying the second images in accordance with the present invention can be accomplished in a number of ways. In a first embodiment, the display screen 2 is arranged in such a way that, under control of the key, it produces a blank screen each time a second image of the sequence was to be displayed. For this purpose an appropriate “blank” signal can be generated in response to a “0” in the key. A display screen which can be blanked in this way may or may not be provided with an illumination unit 3. When the display screen is, for example, a CRT screen, a luminous image can be produced without the need for an illumination unit. If an illumination unit is present in this embodiment, it preferably illuminates the display screen continuously.

In a second embodiment, the display screen 2 displays all (or most) images, that is, both the first and the second images. The illumination unit 3, however, is arranged such that only the first images are illuminated in response to the “1”s contained in the key. As a result of this modulation of the illumination, only the first images are visible. An optional key detector 5, the function of which will be later explained, may also be present.

As stated above, the key 13 may be permanently stored in the display device 1. Alternatively, the key 13 may be stored in a card, for example a smart card (a card for electronic payments or identification), such as a SIM (Subscriber Identity Module) card used in mobile telephones. Such a smart card may be inserted into a smart card reader or similar interface unit which may be present in the display device. Instead of the key itself being stored on a card, it is possible to store a cryptographic seed from which the key may be derived using a suitable algorithm. Such algorithms are well known to those skilled in the art.

Alternatively, the key may be derived from the images. To this end a key detector (5 in FIG. 2) may be provided which produces a detection signal D. The key detector is a light sensor which produces an electrical signal in response to incident light. In some advantageous embodiments a key detection mode may be provided in which the illumination unit 3 illuminates the display screen continuously while the key detector 5 detects the light passing through (FIG. 1) or reflected by (FIG. 2) the display screen 2. Special key images (not shown) may contain the key information itself but preferably information from which the key may be derived, such as a cryptographic seed. To this end, an auxiliary key may be stored in the display device, the auxiliary key being used to derive the session key which identifies the first images. Those skilled in the art will understand that various cryptographic methods may be used to derive the key, for example methods using the DES (Data Encryption Standard) algorithm.

To synchronize the (session) key with the sequence of images various approaches are possible. The sequence of images could be displayed only after pressing a start button or generating a start signal which initiates the key. Alternatively, a detector (for instance the key detector 5 shown in FIG. 2) could detect the start of the sequence. Preferably several special purpose (second) images could be used for this purpose, the detector for instance detecting a light intensity exceeding a threshold level. These special purpose images could for example be entirely white. Alternatively, or additionally, a display driver which may be present in the display device 1 may be used to generate synchronization images. It is noted that these methods of synchronizing a key are not limited to the embodiments discussed above and may also be utilized in Prior Art devices and systems, that is, also in devices and systems requiring a separate “shutter” or similar device for filtering out masking images.

To further enhance the security provided by the present invention each first and second image may be constituted by at least two but preferably three sub-images of different, complementary colors. In such embodiments, the illumination unit 3 is capable of producing those colors in response to the key, which also contains color information. A color sequence S and its corresponding key K are schematically depicted in FIG. 4. Instead of actual first and second images, only the color indications R (red), G (green) and B (blue) are shown for the sake of clarity.

There are three mutually independent (orthogonal) sequences when the colors R (red), G (green) and B (blue) are used: RGB, GBR and BRG. In this embodiment, the key contains color sequence information (coding sequence of first and second images) in addition to, or instead of, location information (relative location of first and second images). In the example of FIG. 4 it is assumed that the images are coded in the color sequence RGB. Each first image 11 will therefore comprise the sub-images R, G and B in that particular order. It will be understood that illuminating the sub-image R (red) with the colors G or B will result in a virtually black image, the red sub-image will only be visible when illuminated with red light. Of course the same holds true for the other colors.

There are several possibilities for color-encoding the images. In one embodiment, all first and second images are encoded in the same way, RGB in the present example. The key will contain the color sequence RGB for the first images only and either one of the other sequences (GBR or BRG) or “0” (no illumination) for the second images, which alternatives both produce a virtually black image. Any attempt to view the images without the key will produce both the first and the second images (including the masking image) when RGB is used and virtually no images when one of the other sequences is used.

In another embodiment, all first and second images are encoded with either RGB, GBR or BRG, preferably chosen at random, the key containing the corresponding color sequence for the first images while containing one of the other sequences, or “0”, for the second images. This embodiment provides an enhanced level of security as an unauthorized viewer cannot predict in which color sequence the first images are encoded.

Although the above discussion focused on a single target image, it will be understood that the present invention is not so limited and that the present invention can be applied to series or sequences of target images, including but not limited to motion pictures. In addition, the illumination unit is shown to be accommodated in the same housing as the display screen. This is, however, not essential and embodiments can be envisaged in which the illumination unit is a separate device which may be carried by its user to decode image sequences displayed on public screens. Also, it is not necessary for any one first image to contain all features of the corresponding target image. Instead, the features of a single target image may be distributed over several first images.

The present invention can be advantageously utilized in mobile telephones, PDAs (Personal Digital Assistants), laptop and desktop computers, bank teller machines, and other devices provided with a display screen on which information, in particular confidential information, may be displayed.

The exemplary system 20 of FIG. 5 comprises a sequence production unit 21 which receives a (target) image and a masking image from an input device 22 and produces a sequence of first and second images. This sequence is then transmitted to a user device 23 via a communications link 24, in the present example a mobile telephone connection. It is noted that the present invention allows the sequence to be broadcast to a group of users as only the user having the appropriate key will be able to view the target image. The user device 23 contains a display device 1 according to the present invention which selectively displays the first images only, thus reproducing the target image.

The present invention is based upon the insight that a target image constituted by actual images which are interspersed with masking images can be viewed by selectively displaying the actual images while suppressing the masking images. The present invention benefits from the further insight that when the suppression of the masking images is carried out in the display device, no additional screening devices are necessary. It is noted that any terms used in this document should not be construed so as limit the scope of the present invention. In particular, the words “comprise(s)” and “comprising” are not meant to exclude any elements not specifically stated. Single (circuit) elements may be substituted with multiple (circuit) elements or with their equivalents. Any reference numerals in the claims should of course not be construed so as to limit their scope.

It will be understood by those skilled in the art that the present invention is not limited to the embodiments illustrated above and that many modifications and additions may be made without departing from the scope of the invention as defined in the appending claims.

1. A display device (1) for displaying a target image contained in a sequence of first images (11) interspersed with second images (12) constituting a masking image, the display device being arranged for substantially exclusively displaying the first images in response to a key (13).

2. The display device according to claim 1, further comprising a non-luminous display screen complemented with an illumination device for illuminated a non-luminous displayed image, wherein the illumination device is arranged for substantially exclusively illuminating the first images in response to the key.

3. The display device according to claim 1, wherein the key (13) comprises a sequence of values, each value corresponding with a first image or a second image and indicating whether the respective image is to be displayed.

4. The display device according to claim 2, wherein the first and/or second images are each constituted by at least two sub-images having complementary colors, the illumination device being capable of producing at least two corresponding colors, and wherein the key comprises a color indication.

5. The display device according to claim 4, wherein three sub-images are associated with each first and/or second image, the respective colors of the three sub-images forming one of three orthogonal color sequences.

6. The display device according to claim 1, wherein the key (13) is carried on an identification device, such as a smart card, which may interface with the display device.

7. A display device for displaying a target image contained in a sequence of first images (11) interspersed with second images (12) constituting a masking image, in particular according to any of the preceding claims, wherein a light detector (5) is provided for producing a key synchronization signal in response to a detected light intensity of first and/or second images.

8. A consumer device comprising a display device (1) according to claim 1, the consumer device preferably being a mobile telephone set or an electronic organizer.

9. A system for securely distributing images, the system comprising sequence production means for producing a sequence of first images (11) together constituting a target image, for interspersing said sequence of first images with second images (12) constituting a masking image, and for generating a key (13) indicative of the location of the first and/or second images in said sequence, a display device (1) for displaying the target image, and transmission means for transmitting the said sequence to the display device, wherein the display device is arranged for substantially exclusively displaying the first images in response to a key (13).

10. A method of displaying a target image contained in a sequence of first images (11) interspersed with second images (12) constituting a masking image, the method comprising the step of substantially exclusively displaying the first images in response to a key (13).
